(19) United States
(12) Patent Application Publication
(10) Pub. No.: US 2018/0179818 A1
(43) Pub. Date: Jun. 28, 2018

(54) Wide Rung Cap, Ladder and Method

(71) Applicants: Chinmoy Banerjee, Schaumburg, IL (US); Daniel C. Mora, Transfer, PA (US); Robert D. Beggs, Stoneboro, PA (US)

(72) Inventors: Chinmoy Banerjee, Schaumburg, IL (US); Daniel C. Mora, Transfer, PA (US); Robert D. Beggs, Stoneboro, PA (US)

(21) Appl. No.: 15/392,055

(22) Filed: Dec. 28, 2016

(51) Int. Cl. E06C 7/08; E06C 1/08

(52) U.S. Cl. CPC E06C 7/084; E06C 1/08

(57) ABSTRACT

A ladder upon which a user can climb has a first rail. The ladder has a second rail. The ladder has a first rung having a width attached to the first rail and second rail. The ladder has a second rung having a width attached to the first rail and second rail. The ladder has a third rung attached to the first rail and second rail. The ladder has a first rung cap riveted to the first rail and second rail and disposed on and in contact with the first rung. The first rung cap having a flat top surface that is wider than the width of the first rung upon which the user can stand. The first rung providing support to the first rung cap. The ladder has a second rung cap riveted to the first rail and second rail and disposed on and in contact with the second rung. A rung cap. A method for a user to climb a ladder. A method for making a ladder.

### FIELD OF THE INVENTION

The present invention is related to a rung cap on a rung of a ladder where the rung cap has a width greater than the width of the rung. (As used herein, references to the “present invention” or “invention” relate to exemplary embodiments and not necessarily to every embodiment encompassed by the appended claims.) More specifically, the present invention is related to a rung cap on a rung of a ladder where the rung cap has a width greater than the width of the rung and where the rung cap is riveted to the rails of the ladder to provide a more comfortable and secure place on which a user stands while on the ladder.

### BACKGROUND OF THE INVENTION

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

When using a ladder, the wider the rung that the user stands on, typically the more secure the user feels standing on the rung because the wider the rung, the wider the surface area for the user to place his or her feet on the rung. By having a greater surface area, it feels more like standing on the ground or a floor that is the natural position for a user when standing.

The rung cannot be so wide that it interferes with the user climbing the rungs and possibly catching a foot on the rung as a user climbs a ladder, or striking a knee against the rung as the user lifts his or her leg as the user climbs the ladder. In addition, the rung should not be so wide that it could catch on an object when the ladder is being moved, or make it difficult for the ladder to be stored. Furthermore, in regard to an extension ladder, the rungs should not interfere with the movement of the sections of the extension ladder. In regard to a step ladder, the rungs should not impede with the opening and closing of the sections. Accordingly, it is generally desired to provide for a rung with a width as large as possible given the aforementioned constraints.

### BRIEF SUMMARY OF THE INVENTION

The present invention pertains to a ladder upon which a user can climb. The ladder comprises a first rail. The ladder comprises a second rail. The ladder comprises a first rung having a width attached to the first rail and second rail. The ladder comprises a second rung having a width attached to the first rail and second rail. The ladder comprises a third rung attached to the first rail and second rail. The ladder comprises a first rung cap riveted to the first rail and second rail and disposed on and in contact with the first rung. The first rung cap having a flat top surface that is wider than the width of the first rung upon which the user can stand. The first rung providing support to the first rung cap. The ladder comprises a second rung cap riveted to the first rail and second rail and disposed on and in contact with the second rung. The second rung cap having a flat top surface that is wider than the width of the second rung upon which the user can stand. The second rung providing support to the first rung cap.

The present invention pertains to a rung cap that is riveted to a first rail and a second rail of a ladder and is disposed on top of and in contact with a rung of the ladder. The rung cap comprises a standing portion having a right side and a left side and a right flange attached to the right side which extends above the standing portion, and a left flange attached to the left side which extends above the standing portion. The right flange and left flange each having rivet holes through which rivets extend to rivet the right flange to the first rail and the left flange to the second rail. The standing portion having a flat surface and having a rectangular shape and on which the user can stand.

The present invention pertains to a method for a user to climb a ladder having a first rail and a second rail and a first rung. The method comprises the steps of placing the ladder in a desired position. There is the step of a user climbing the ladder. There is the step of the user standing on a first rung cap of the ladder. The first rung cap riveted to the first rail and second rail and disposed on and in contact with the first rung. The first rung cap having a flat top surface that is wider than a width of the first rung upon which the user can stand. The first rung providing support to the first rung cap.

The present invention pertains to a method for making a ladder. The method comprises the step of attaching a first rung to a first rail and a second rail of the ladder. There is the step of riveting a first rung cap to the first rail and second rail of the ladder. The first rung cap disposed on and in contact with the first rung. The first rung cap having a flat top surface that is wider than a width of the first rung upon which the user can stand. The first rung providing support to the first rung cap.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1 shows a ladder of the present invention.

FIG. 2 shows a rung cap.

### DETAILED DESCRIPTION OF THE INVENTION

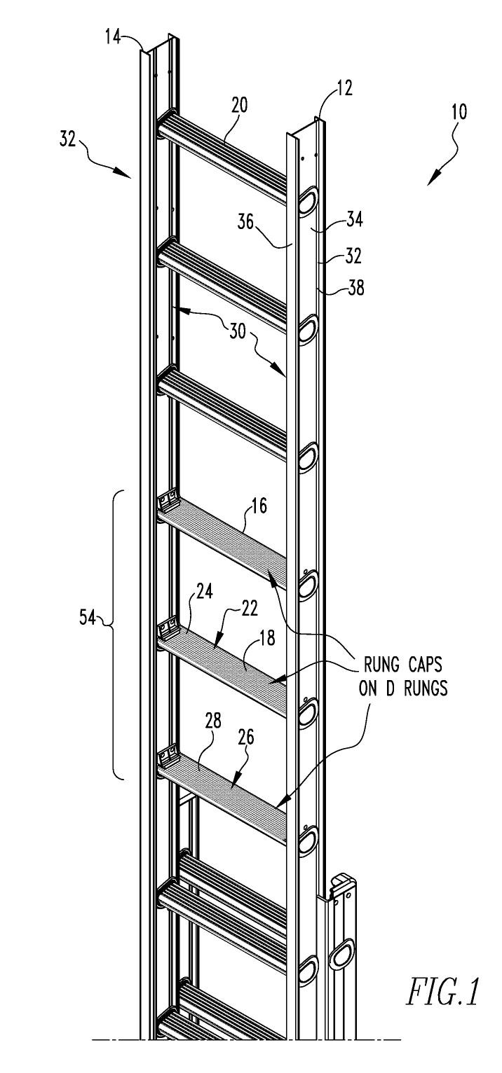

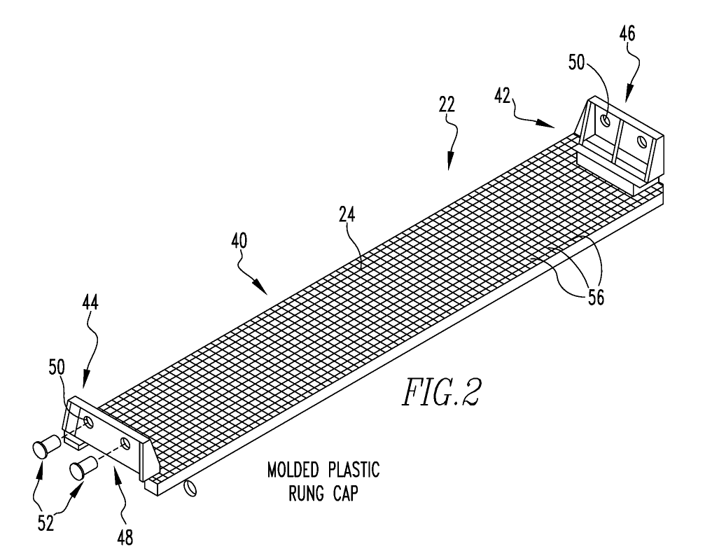

Referring now to the drawings wherein like reference numerals refer to similar or identical parts throughout the several views, and more specifically to FIGS. 1 and 2 thereof, there is shown a ladder 10 upon which a user can climb. The ladder 10 comprises a first rail 12. The ladder 10 comprises a second rail 14. The ladder 10 comprises a first rung 16 having a width attached to the first rail 12 and second rail 14. The ladder 10 comprises a second rung 18 having a width attached to the first rail 12 and second rail 14. The ladder 10 comprises a third rung 20 attached to the first rail 12 and second tail 14. The ladder 10 comprises a first rung cap 22 riveted to the first rail 12 and second rail 14 and disposed on and in contact with the first rung 16. The first rung cap 22 having a flat top surface 24 that is wider than the width of the first rung 16 upon which the user can stand. The first rung 16 providing support to the first rung cap 22. The ladder 10 comprises a second rung cap 26 riveted to the first rail 12 and second rail 14 and disposed on and in contact with the second rung 18. The second rung cap 26 having a flat top surface 28 that is wider than the width of the second rung 18 upon which the user can stand. The second rung 18 providing support to the first rung cap 22.

Each rail may have an inner side 30 and an outer side 32 and a web 34 and a first flange 36 attached to a first side of the web 34 and the second flange 38 attached to a second side of the web 34. Each rung cap attached to the web 34 of the first rail 12 and the second rail 14 on the inner side 30 of the first rail 12 and the second rail 14. Each rung cap may have a standing portion 40 having a right side 42 and a left side 44 and a right flange 46 attached to the right side 42 which extends above the standing portion 40, and a left flange 48 attached to the left side 44 which extends above the standing portion 40. The right flange 46 and left flange 48 each having rivet holes 50 through which rivets 52 extend to rivet the right flange 46 to the first rail 12 and the left flange 48 to the second rail 14. The standing portion 40 having the flat surface and having a rectangular shape and on which the user can stand.

The first rung cap 22 and second rung cap 26 may be disposed only in a work zone 54 of the ladder 10 where the user is most likely to stand while working from the ladder 10. Each rung cap may be molded plastic. The standing portion 40 may have open spaces 56. Each rung cap may support at least 300 pounds without failing.

The present invention pertains to a rung cap that is riveted to a first rail 12 and a second rail 14 of a ladder 10 and is disposed on top of and in contact with a rung of the ladder 10. The rung cap comprises a standing portion 40 having a right side 42 and a left side 44 and a right flange 46 attached to the right side 42 which extends above the standing portion 40, and a left flange 48 attached to the left side 44 which extends above the standing portion 40. The right flange 46 and left flange 48 each having rivet holes 50 through which rivets 52 extend to rivet the right flange 46 to the first rail 12 and the left flange 48 to the second rail 14. The standing portion 40 having a flat surface and having a rectangular shape and on which the user can stand.

The present invention pertains to a method for a user to climb a ladder 10 having a first rail 12 and a second rail 14 and a first rung 16. The method comprises the steps of placing the ladder 10 in a desired position. There is the step of a user climbing the ladder 10. There is the step of the user standing on a first rung cap 22 of the ladder 10. The first rung cap 22 riveted to the first rail 12 and second rail 14 and disposed on and in contact with the first rung 16. The first rung cap 22 having a flat top surface 24 that is wider than a width of the first rung 16 upon which the user can stand, the first rung 16 providing support to the first rung cap 22.

The present invention pertains to a method for making a ladder 10. The method comprises the steps of attaching a first rung 16 to a first rail 12 and a second rail 14 of the ladder 10. There is the step of riveting a first rung cap 22 to the first rail 12 and second rail 14 of the ladder 10. The first rung cap 22 disposed on and in contact with the first rung 16. The first rung cap 22 having a flat top surface 24 that is wider than a width of the first rung 16 upon which the user can stand. The first rung 16 providing support to the first rung cap 22.

This invention consists of a cover or cap which is designed to lie on top of an extension ladder 10 rung and be attached to it by rivets 52. The cap can be molded plastic or formed from other materials, such as aluminum or carbon reinforced fiberglass or steel, using other processes such as extrusion. This cap is wider from front to rear than the conventional ladder rungs to which it attaches. This extra width provides a more comfortable surface to stand on for extended lengths of time. It is intended that these rung caps be installed on the rungs near the top of the fly section of the ladder 10, the “work zone”, where the user is most likely to stand when working. The rung caps, as described herein, are used on extension ladders. These rung caps can also be used in the “work zone” of a climbing product and can be extended to rung cap ladders, MT ladders, M ladders, attic ladders, etc. Preferably, the first rung cap 22 has a width that is less than the width of the web of the first and second rails so that it does not extend beyond the rails and create a possible obstruction for a user to strike his or her knee or foot against as they are climbing the ladder. The width of the first rung cap 22 may be between 2 inches and 6 inches, and the length may be between 10 inches and 20 inches, depending on the size of the ladder to which the first rung cap 22 is being attached. The thickness of the first rung cap 22 may be between ⅛ inch and ⅜ inch. The right and left flanges should have the same with as the first rung cap 22 and extend upwards from the standing portion between 1 inch and 4 inches. The standing portion and the flanges may be one continuous piece. Buttressing, as shown in FIG. 2, may be used to provide additional support to the first and second flanges. For instance, 3 individual buttresses extending from the surface of the standing portion to the inner side of the flange, where the outer side of the flange contacts the web of the rail to which the flange is riveted, with the buttresses being one continuous piece with the flange and the standing portion. For clarification purposes, the length of the rung cap is the distance between the first rail and the second rail, while the width of the rung cap is the distance between the front and the back of the rung cap, where the width is essentially perpendicular to the length, and a user normally placing a foot across the width of the rung cap.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1: A ladder upon which a user can climb comprises:
a first rail;
a second rail;
a first rung having a width attached to the first rail and second rail;
a second rung having a width attached to the first rail and second rail;
a third rung attached to the first rail and second rail;
a first rung cap riveted to the first rail and second rail and disposed on and in contact with the first rung, the first rung cap having a flat top surface that is wider than the width of the first rung upon which the user can stand, the first rung providing support to the first rung cap; and
a second rung cap riveted to the first rail and second rail and disposed on and in contact with the second rung, the second rung cap having a flat top surface that is wider than the width of the second rung upon which the user can stand, the second rung providing support to the first rung cap.

2: The ladder of claim 1 wherein each rail has and inner side and in outer side and a web and a first flange attached to a first side of the web and the second flange attached to a second side of the web, each rung cap attached to the web of the first rail and the second rail on the inner side of the first rail and the second rail.

3: The ladder of claim 2 wherein each rung cap has a standing portion having a right side and a left side and a right flange attached to the right side which extends above the standing portion, and a left flange attached to the left side which extends above the standing portion, the right flange and left flange each having rivet holes through which rivets extend to rivet the right flange to the first rail and the left flange to the second rail, the standing portion having the flat surface and having a rectangular shape and on which the user can stand.

4: The ladder of claim 3 wherein the first rung cap and second rung cap are disposed in a work zone of the ladder where the user is most likely to stand while working from the ladder.

5: The ladder of claim 4 wherein each rung cap is molded plastic.

6: The ladder of claim 5 wherein the standing portion has open spaces.

7: The ladder of claim 6 wherein each rung cap can support at least 300 pounds without failing.

8: A rung cap that is riveted to a first rail and a second rail of a ladder and is disposed on top of and in contact with a rung of the ladder comprising:
a standing portion having a right side and a left side and a right flange attached to the right side which extends above the standing portion, and a left flange attached to the left side which extends above the standing portion, the right flange and left flange each having rivet holes through which rivets extend to rivet the right flange to the first rail and the left flange to the second rail, the standing portion having a flat surface and having a rectangular shape and on which the user can stand.

9-10. (canceled)
